(19) United States
(12) Patent Application Publication
(10) Pub. No.: US 2019/0017695 A1
(43) Pub. Date: Jan. 17, 2019

(54) Candle Holder with Speakers

(71) Applicant: Arts and Things Inc., Monroe, NY (US)

(72) Inventor: Joel Goldstein, Monroe, NY (US)

(21) Appl. No.: 15/647,195

(22) Filed: Jul. 11, 2017

(51) Int. Cl. F21V 35/00; H04R 1/02

(52) U.S. Cl. CPC F21V 35/00; H04R 2420/07; H04R 1/028

(57) ABSTRACT

A candle holder featuring a support portion configured to support a candle and a bottom chamber configured to contain a speaker and a power supply. The speaker is configured to receive music data over Wi-Fi or Bluetooth.

### BACKGROUND

There are currently electric candles on the market equipped with speakers for playing music. However, electric candles lack the authenticity and atmosphere of real candles. Since these candles are sometimes used to create romantic settings for couples, authenticity and atmosphere are priorities. Real candles are often used but not combined with speakers for the playing of music selected by the user. There are commercially available candles fitted with speakers and pre-loaded songs, but these are generally intended for birthdays or religious ceremonies, and so the songs are not of the romantic type. Also, the need for authenticity is based on the integrity and uniqueness of the feelings between couples, and therefore the user will wish to select a song that is unique to the couple. It is not feasible, or even possible, to preload every song that a user will want to play, and therefore, the speaker must be able to connect to a song database or channel selected by the user. To this end, there is a need for real wax candles fitted to a candle holder featuring a speaker configured to play songs of the user's choice.

### SUMMARY

In one embodiment, the candle holder comprises a platform. The platform is a support portion designed to receive a candle. The support portion is basically flat, and may be round, square, or any conceivable shape likely to be flush against the bottom surface of a candle. In one variation, the support portion features a pin or conical edge protruding orthogonally in order to pierce or otherwise grasp a candle placed upon it.

The support portion may be made of any conceivable material, but ideally, is comprised of a thermally non-conductive material in order to prevent heat from being communicated from the candle.

In one embodiment, the support portion may feature one or more side walls. These side walls may extend from a peripheral portion of the support portion, rising between zero and four inches from the support portion, though other heights are also conceivable.

In one variation, the side walls are removably attached to the support portion, allowing the support portion and/or side walls to be cleaned of wax or other debris separately.

In another variation, the side walls feature a plurality of openings. These openings are designed to alternately reveal and conceal light from the candle in a pattern, so that the patterned light rays will emit from the candle holder onto a room, thereby producing patterns of light onto the walls.

In yet another variation, the side walls feature a plurality of gates that can be used to conceal the openings. If the side walls are cylindrical, the gates can be rotated around the side walls to cover the openings entirely.

In an additional variation, the side walls may comprise a plurality of layers, each layer having a unique property. For example, one layer may be transparent, another layer may be opaque, and a third layer may be patterned. One or more layers may also feature semi-transparent colors designed to filter the light rays.

In one embodiment, the candle holder may feature a lid. The lid may be placed atop the side walls to shield access to the candle flame and thereby prevent injuries. Also, the lid may be used to block the supply of oxygen and kill the flame.

In one embodiment, the candle holder may feature a bottom chamber. The bottom chamber may be disposed beneath the support portion and may be shaped to receive and contain one or more speakers. In one variation, the bottom chamber is also shaped to receive and contain a power source, such as a battery cell.

The bottom chamber may have a bottom portion configured to be placed on a surface such as a table, a nightstand, or the floor. This bottom portion may feature scuff-resistant pads to prevent scratching or scuffing of the surface. In one variation, a battery cell is accessible from the bottom portion.

The bottom chamber may feature one or more side walls. The side walls of the bottom chamber may be continuous with the side walls of the support portion. The bottom chamber side walls may feature one or more openings to permit sound from at least one speaker to emit outwards from the device. The openings may be configured to receive a portion of a speaker so that the speaker itself is either flush with or protrudes from the bottom chamber side walls. In one variation, a battery cell is accessible from the bottom portion.

If the bottom chamber side walls are substantially curved, an exposed portion of the speaker may also be curved so that when it is disposed at an opening, the exposed portion is flush with a bottom chamber side wall.

In one variation, the bottom chamber and the support portion are removably attachable, thereby allowing the support portion to be cleaned of wax or other debris using water, soap, or other means, thereby preventing the speaker and power source from being damaged by those elements.

In one variation, the support portion comprises a rim, the rim being wider than the portion of the bottom portion that connects to the support portion. This rim is designed to receive the wax that melts off the candle and prevents it from flowing onto the bottom portion. The rim may curve upward in order to create a well in which the wax may rest after hardening.

In one version, the bottom chamber and the support portion are threadably aligned so that they may be separated by rotating one with respect to the other. In another version, the bottom chamber and the support portion engage by means of a snap-fit, where one may be tightly pressed over or into the other. In one variation, the bottom chamber may be separated from the support portion to reveal a cavity within the bottom chamber. The cavity may be composed of the one or more side walls and the bottom portion of the bottom chamber. The cavity may provide access to the battery cell and/or at least one speaker.

In a variation featuring multiple speakers, the multiple speakers may be positioned in different positions of the cavity, with the sound-emitting surfaces facing different directions. Accordingly, the bottom portion side wall windows may be disposed at different angles from the center. In one version, two windows are disposed between 10-30 degrees away. In another version, two windows are disposed between 30 and 45 degrees away. In yet another version, two windows are disposed between 45 and 60 degrees away. In an additional version, two windows are disposed between 60 and 90 degrees away. In a further version, two windows are disposed between 90 and 180 degrees away. It is also conceivable that more than two windows may be disposed for more than two speakers.

In another variation, speakers may be specialized between the classes of treble, mid-range, and bass. In this variation, the bottom portion of the bottom chamber may feature a window configured to fit the sound-emitting surface of a bass speaker.

The one or more speakers may be wirelessly connected to a music streaming source, such as one or more of many commercially available media platforms. The selection of music may be controlled by a remote device such as a smart phone. The speaker may also be configured to play music stored on the smart phone. The wireless protocol may be Wi-Fi or Bluetooth.

In one variation, the lid is mechanically connected to a motor, and the motor is connected to the power source. The motor may be disposed substantially in the bottom portion cavity but be connected to one or more beams that control the position or orientation of the lid. In this variation, the motor may also be connected to a smart phone by Wi-Fi or Bluetooth, enabling a user to remotely close the lid and kill the flame.

### BRIEF DESCRIPTION OF THE DRAWINGS

FIG. 1A shows an exemplary candle holder.

FIG. 1B shows an exemplary candle holder featuring a candle.

FIG. 2A shows an exemplary candle holder featuring one or more side walls.

FIG. 2B shows an exemplary candle holder featuring threaded coupling.

FIG. 3A shows an exemplary candle holder featuring a battery cell.

FIG. 3B shows an exemplary candle holder featuring a motor.

FIG. 4A shows an exemplary candle holder featuring a patterned wall.

FIG. 4B shows an exemplary candle holder featuring a bass speaker.

### DETAILED DESCRIPTION

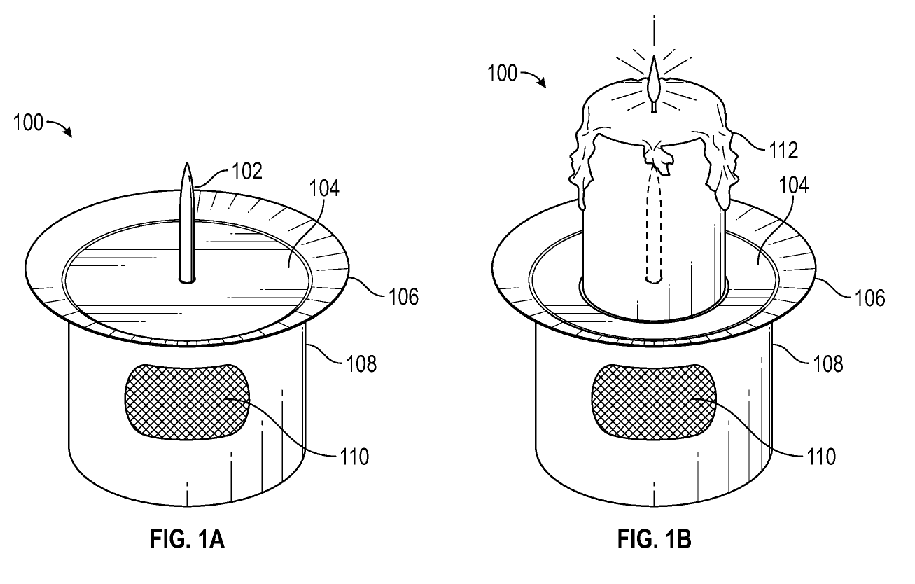

FIG. 1A shows a candle holder 100 featuring a pin 102 disposed on a support portion 104. The support portion has a rim 106 for receiving and containing the wax from a melting candle. The candle holder also has a bottom chamber 108 which contains a speaker 110. FIG. 1B shows a candle 112 placed on top of the support portion.

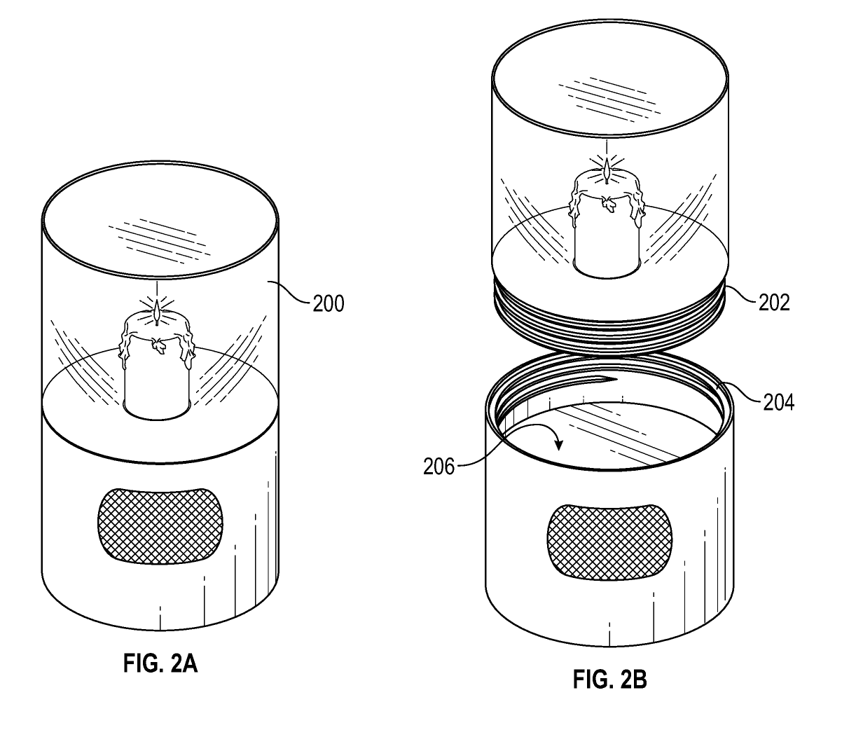

FIG. 2A shows a transparent wall 200 extending from the support portion. FIG. 2B shows a first set of threads 202 disposed on the support portion and a second set of threads 204 disposed on the bottom chamber. The bottom portion may also feature a cover 206. The cover may be opened to reveal a cavity in the bottom portion.

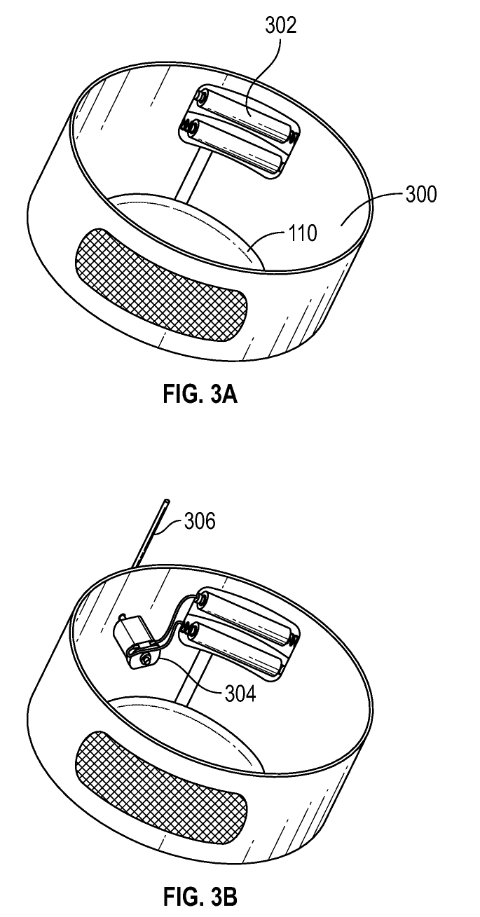

FIG. 3A shows a cavity 300 and a power supply such as a battery cell 302. In FIG. 3B, the cavity also houses a motor 304 coupled to a rod 306 for raising a lid.

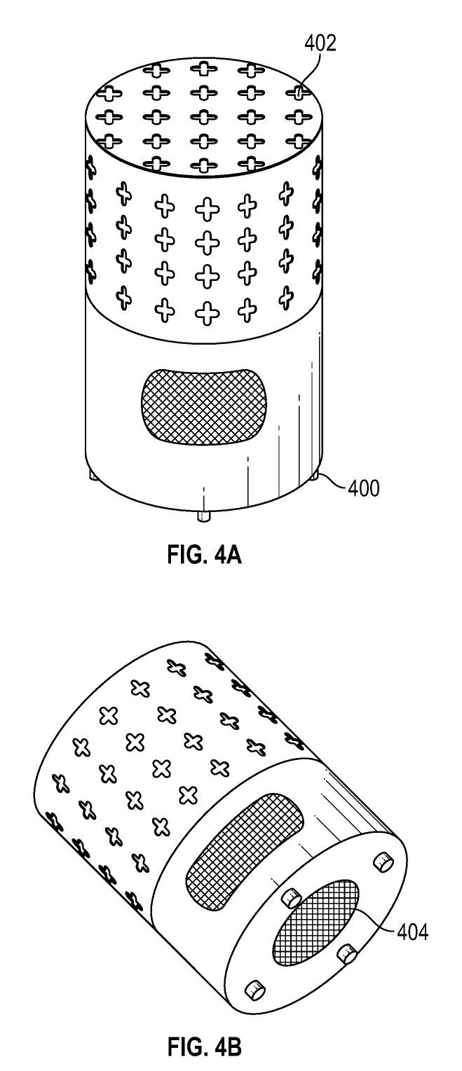

FIG. 4A shows a set of legs 400 and a lid 402. The walls here are not fully transparent but instead features an opaque or semi opaque pattern. FIG. 4B shows a bottom or bass speaker 404 protruding from the bottom of the bottom chamber.

1. A candle holder, comprising a bottom chamber and a support portion, the support portion comprising one or more upper side walls and configured to receive and support a candle, the bottom chamber comprising a cavity, a bottom portion, and one or more chamber side walls and configured to receive a speaker and a power supply, the one or more chamber side walls connected to a peripheral portion of the bottom portion.

2. The candle holder in claim 1, the chamber side walls being continuous with the upper side walls of the support portion.

3. The candle holder in claim 1, the bottom chamber being removably attachable to the support portion.

4. The candle holder in claim 1, the support portion comprising a rim.

5. The candle holder in claim 1, each upper side wall having a unique attribute from a set of attributes including: transparent, opaque, colored, patterned.

6. A candle holder in claim 1, at least one chamber side wall comprising one or more openings, at least one of the one or more openings configured to receive an exterior portion of a speaker.

7. The candle holder in claim 6, the exterior portion of the speaker being flush with the at least one chamber side wall.

8. The candle holder in claim 6, the exterior portion of the speaker protruding through the at least one of the one or more openings.

9. The candle holder in claim 1, the candle holder additionally comprising a bass speaker, the bottom portion comprising a bottom opening, the bottom opening configured to receive an exterior portion of the bass speaker.

10. The candle holder in claim 1, the support portion comprising a pin, the pin extending orthogonally from the support portion.

11. The candle holder in claim 1, the support portion made of thermally non-conductive material.

12. The candle holder in claim 1, the upper side walls being between zero and four inches in height from the support portion.

13. The candle holder in claim 3, the bottom chamber and support portion being threadably engaged.

14. The candle holder in claim 1, additionally comprising a lid and a motor, the lid being mechanically coupled to the motor, the motor being electrically connected to the power source.

15. The candle holder in claim 1, the power supply being a battery.

16. The candle holder in claim 1, the speaker configured to receive music data via Wi-Fi.

17. The candle holder in claim 1, the speaker configured to receive music data via Bluetooth.

18. The candle holder in claim 1, the speaker configured to receive music data via Bluetooth and Wi-Fi.

19. A candle holder, comprising a bottom chamber and a support portion,
the bottom chamber and the support portion being threadably engaged;
the support portion comprising a pin and one or more upper side walls, the pin configured stick a candle, the support portion configured to support the candle, the support portion being made of thermally non-conductive material; and
the bottom chamber comprising a cavity, a bottom portion, and one or more chamber side walls and configured to receive a speaker and a power supply, the one or more chamber side walls connected to a peripheral portion of the bottom portion.

20. A candle holder, comprising a bottom chamber and a support portion, the support portion comprising a rim and a pin and configured to receive and support a candle, the bottom chamber comprising a cavity, a bottom portion, and one or more chamber side walls and configured to receive a speaker and a power supply, the one or more chamber side walls connected to a peripheral portion of the bottom portion.
